(19) United States
(12) Patent Application Publication
(10) Pub. No.: US 2004/0078430 A1
(43) Pub. Date: Apr. 22, 2004

(54) Method to facilitate a collaborative supply of materials

(75) Inventors: Roch Joseph Aubert, Grayslake, IL (US); Neil Nodwell, Danbury, CT (US); Daniel Patrick Tennant, Batavia, IL (US); James Ellis Fehlberg, Hoffman Estates, IL (US); Monica Leona Zoellner, Chicago, IL (US); Christopher James D'Alessio, Gurnee, IL (US); James Scott Vargas, Chicago, IL (US); John Jerald Pulford, Grayslake, IL (US); Eveline Korczynski, Arlington Heights, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/277,633

(22) Filed: Oct. 22, 2002

(51) Int. Cl. G06F 15/16

(52) U.S. Cl. 709/204

(57) ABSTRACT

A manufacturer and one or more suppliers can share information of various kinds and collaborate in various ways by interfacing via a collaborative supply server. Various task areas are supported, including a grouping area (20), a forecast area (21), an inventory area (22), an exceptions area (23), and a change management area (24). The change management area integrates a number of capabilities to benefit both manufacturer and supplier and can present information regarding individual resources (and resources that relate thereto) and consumption start and stop dates. A comments area permits the relevant parties to exchange messages regarding such resources. The change management display can be used to facilitate automatic modification of inbound supply chain forecast information of the indicated resources.

### TECHNICAL FIELD

This invention relates generally to materials supply management.

### BACKGROUND

Various ways and means of facilitating a supply of materials to a manufacturer are known. Also reasonably well known are the risks and problems associated with an unmanaged supply chain. At one extreme, a necessary material becomes unavailable and manufacturing must halt regardless of how well supplied the manufacturer may be with respect to other materials. At the other extreme, the manufacturer has more material than can possibly be used within a reasonable period of time and must therefore assume both the cost of having and safeguarding the material. Proper management of a supply of materials to support a manufacturing process therefore essentially involves attempting to find and maintain a balance between manufacturing needs and schedules on the one hand and minimizing expenditures and inventory expenses on the other hand.

Attempting to achieve such a balance ordinarily requires considerable data gathering and constant attention to detail with respect to changing circumstances for a number of parties (including usually, at least, various parties within the manufacturer and one or more suppliers). Things can and will change on a frequent basis. For example, new orders can quickly increase the need for raw materials while cancelled orders can rapidly result in the opposite.

To attempt to accommodate these conditions, materials supply management will often practice both forecasting and inventory monitoring. Forecasting in general comprises the activity of estimating manufacturing needs and scheduling and of determining what raw materials are needed (by quantity, date, and location) to support those manufacturing needs. Inventory monitoring in general comprises keeping tabs on what raw materials are on hand as well as the location of those raw materials. Using such tools, a materials supply manager will then seek to acquire additional raw materials as needed to meet scheduled manufacturing needs while also working to keep available inventory at some reasonable level.

Effecting such activities becomes challenging as the size of the manufacturing enterprise increases. A modern consumer products manufacturer will often manufacture hundreds (or thousands) of products at dozens of geographically scattered facilities. Simply keeping track of the raw material needs of a large enterprise can prove difficult. The problems that beset balancing raw materials needs against desired modest inventory levels are increased further when such an enterprise has dozens, hundreds, or even thousands of raw materials suppliers to deal with. Simply keeping track of the who, what, when, and where for raw materials needs in such a setting will often result in a regular and recurring flood of data. Elaborate and large hierarchical organizations are often constructed and enlisted in the course of trying to ensure good decision making in the face of so many facts in motion.

Some efforts have been made to enlist the aid of raw materials suppliers in these efforts. Efforts have also been made to automate, to at least some extent, certain aspects of the overall process and/or to attempt to increase the effectiveness of communications regarding such data and related decisions. In general, however, no highly integrated and suitably effective solution has been proposed. One or more faults tend to characterize such efforts, including at least one or more of these problems:

Gathered data is, or becomes, quickly stale and out-of-date;

Data is too closely held and not sufficiently available for use and/or inspection and correction;

Information access is slow, limited, and/or unfriendly;

Communications between necessary parties is slow, uncertain, without context, and/or unsupported;

The would-be manager faces an immense quantity of data to assimilate and use effectively;

Necessary changes (to, for example, a schedule, a quantity, a shipping destination, a product, product packaging, and the like) are difficult to implement and/or communicate;

Important elements of a reasonable materials supply management effort are missing or unsupported; and

One party's solution is incompatible or otherwise difficult to implement in combination with another party's internal practices and platforms (thereby making it hard to facilitate coordinated actions by both a manufacturer and a field of suppliers).

In addition to the above, at least one other factor often magnifies these shortcomings of the prior art; the need for many manufacturers (particularly those that deal with consumer products) to quickly alter in various ways their product base. For example, a given manufacturer may have a given basic product but will vary the packaging of that product a number of times during the course of a year. For example, packaging graphics may be changed to reflect seasonal elements or other promotional themes and events. In this regard, consider a simple example:

Manufacturer A manufactures a given product and packages it in three different sizes (small, medium, and large, for example) and distributes this product in North America. To accommodate Halloween in the United States and Canada, the graphics for the small and medium packages of the product have a Halloween motif for approximately one month of consumer exposure (the large package does not have a Halloween motif). The graphics of the small and medium packages are then switched to a Thanksgiving motif for one month (with the large package again continuing with standard graphics). The graphics of all three package sizes then assume a Christmas motif for six weeks of consumer exposure. Ensuring that the correct quantity and type of packaging is available to the manufacturer at the right times and places, while also ensuring that an unacceptable inventory build-up is not also occurring with respect to any of the packaging options, can represent a considerable challenge for all the reasons set forth above and more.

The real problem, of course, is considerably larger and more complicated than this simple example. Introducing an enterprise having dozens of manufacturing facilities that produce hundreds or thousands of products using materials from hundreds or thousands of suppliers into this illustrative problem should readily suggest to the reader some sense of the scope of the problem as well as the need for a solution.

### BRIEF DESCRIPTION OF THE DRAWINGS

The above needs are at least partially met through provision of the method to facilitate a collaborative supply of materials described in the following detailed description, particularly when studied in conjunction with the drawings, wherein:

FIG. 1 comprises a block diagram of a system as configured in accordance with an embodiment of the invention;

FIG. 2 comprises a general schematic of the task-based architecture of a system as configured in accordance with an embodiment of the invention;

FIG. 3 comprises an illustrative example of a display layout for a grouping task area as configured in accordance with an embodiment of the invention;

FIG. 4 comprises an illustrative example of a display layout detail for a grouping task area as configured in accordance with an embodiment of the invention;

FIG. 5 comprises an illustrative example of a display layout for a forecast task area as configured in accordance with an embodiment of the invention;

FIG. 6 comprises an illustrative example of a display layout for an inventory task area as configured in accordance with an embodiment of the invention;

FIG. 7 comprises a general schematic of the logical layout for an exceptions task area as configured in accordance with an embodiment of the invention;

FIG. 8 comprises an illustrative example of a display layout for an exceptions task area as configured in accordance with an embodiment of the invention;

FIG. 9 comprises an illustrative example of a display layout for a detail screen within an exceptions task area as configured in accordance with an embodiment of the invention;

FIG. 10 comprises an illustrative example of a display layout for a change number locator area within a change management task area as configured in accordance with an embodiment of the invention;

FIG. 11 comprises an illustrative example of a display layout for a change management task area as configured in accordance with an embodiment of the invention; and

FIG. 12 comprises an illustrative example of a display layout for a detail screen within a change management task area as configured in accordance with an embodiment of the invention.

Skilled artisans will appreciate that elements in the figures are illustrated for simplicity and clarity and have not necessarily been drawn to scale. For example, the dimensions of some of the elements in the figures or the distances therebetween may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, a method allows for presentation and use of an integrated change management interface that permits, for example, identifying at least one specific material to be supplied by at least one of many suppliers and a corresponding date by when consumption of that specific material is scheduled to begin. The interface further presents a comments area where change management comments from the manufacturer and the suppliers can be entered and displayed. The interface also further presents a resource modification selector section where the specific material can be correlated with at least one prior material wherein completion of consumption of the prior material by the manufacturer prior to beginning consumption of the specific material is desired. In one embodiment, this interface is used to facilitate automatic modification of inbound supply chain forecast information with respect to the prior material.

So configured, the present inventory of the prior material (such as packaging that is to be discontinued on a certain date) and the continued incoming receipt of that prior material is monitored and weighed against present actual and predicted usage. This permits the inventory and orders for the prior material to properly dwindle such that an inappropriate quantity will not remain on hand when the scheduled switch to the new packaging (i.e., the specific material in this example) occurs. Simultaneously, an appropriate supply and availability of the new packaging can be assured to support the switchover on the scheduled date. Such benefits and many others readily flow through implementation and use of the various embodiments set forth herein.

In one embodiment, the date by when consumption of the prior material should be at least substantially consumed is automatically scheduled as a function of the date by when consumption of the new specific material is scheduled to begin. If desired, the interface can serve to correlate a plurality of new resources or materials with a plurality of corresponding prior materials to thereby further facilitate beneficial tracking and controls.

In one embodiment, a comments area includes at least two discrete comments areas. So configured, comments by the manufacturer and by a supplier are readily distinguishable. These comments areas can, if desired, be disposed proximal to one another and can be scrollable to readily accommodate a considerable quantity of comments. This facilitates quick and effective communications between the manufacturer and the suppliers with messages that have a clear context and relevance.

In one embodiment, some information (such as, for example, inbound supply chain forecast information) is stored in memory and may be updated, for example, on a daily basis. Such a modification schedule, though frequent, may not keep pace with all necessary changes. The integrated change management display can also be used, if desired, to facilitate automatic modification of the inbound supply chain forecast information other than as stored in the memory (for example, by retrieving the information from the memory and then automatically modifying the information to conform to forecast information as has been specified through use of the integrated change management display). Such a process can be essentially transparent to the user. Of course, when the stored information is next updated, the automatic modification can then be dispensed with.

These and many more embodiments and variations are set forth herein. Separately and together these various embodiments and features serve to greatly ease and facilitate the ability of an enterprise to manage its raw materials needs and usage in a cost efficient and effective fashion.

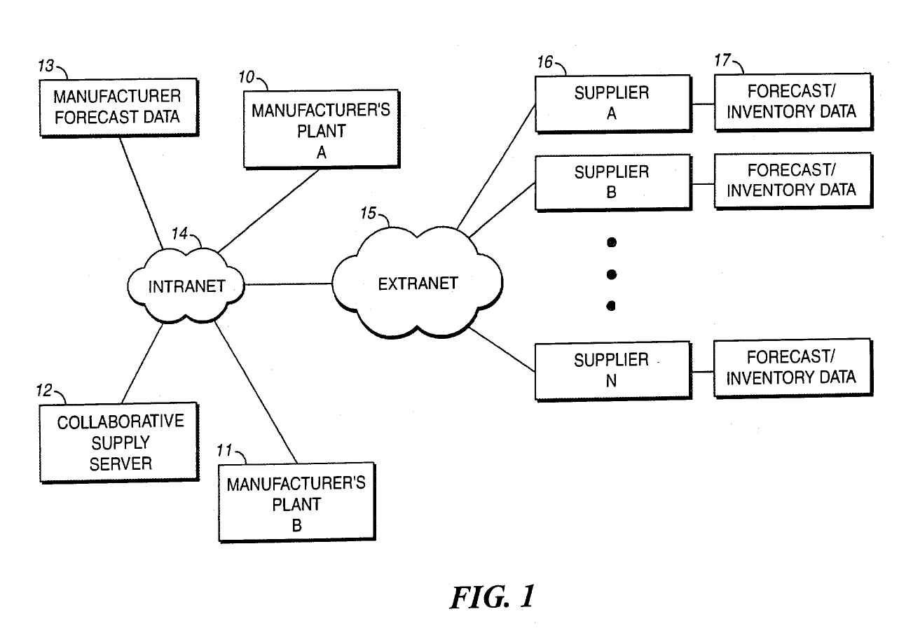

Referring now to the drawings and in particular to FIG. 1, a given manufacturing enterprise will typically have a number of manufacturing facilities (for purposes of clarity, only two such plants 10 and 11 are shown in this illustration; it should be understood that any number of plants can be accommodated via these embodiments). These manufacturing facilities may, or may not, be located proximal to one another and may, or may not, share production of a common product. More typically, each plant will make, from time to time, a number of products. In addition, each such plant may package such products in a variety of different sizes, styles, and packages to accommodate various target consumers, promotional efforts, and distribution chains. Pursuant to a preferred embodiment, a collaborate supply server 12 will serve as a platform for some or all of the functionality described below. In this particular embodiment, a forecast data repository 13 also comprises a part of the enterprise (for example, such a repository can exist as a legacy system that the enterprise has used to store forecast data for its various products and plants and which information is now being made available to the collaborative supply server 12). In this particular embodiment, this memory 13 serves to store at least some of the inbound supply chain forecast information for the enterprise. Also in this embodiment, this forecast information is updated on a daily basis. These various elements are intercoupled in a known way via an appropriate intranet (or, if desired, through an extranet such as the Internet; an intranet is generally preferred in part because such a configuration makes at least some security issues easier to address as well understood in the art).

So configured, data, inquiries, and other materials management information can be readily moved about the enterprise. It should be understood that a number of other participants and facilities would likely be included as part of a comprehensive installation. For example, headquarters operations, regional offices, warehouses and other common functional units and components of a manufacturing operation would likely, and in a preferred embodiment should, have access to the configuration already described. Such access is of course readily available via the intranet 14 as well understood in the art. In this way, virtually everyone in the enterprise who needs access to the system (either to input information, monitor information, or respond to information) can be assured of such access.

By connecting this enterprise infrastructure to an appropriate shared network such as an extranet (for example, the Internet), the enterprise can also be coupled to a first supplier (such as Supplier A 16) and any number of additional suppliers. As already mentioned, a large consumer product oriented manufacturing enterprise may well have established relations with thousands of suppliers in order to have access to the raw materials needed to manufacture and appropriately package their various products. Typically, some or all of these suppliers will have their own internal forecast/inventory data system 17. In many cases, such systems represent unique and/or highly customized platforms that are not readily directly compatible with many or most other systems. The embodiments described herein do not, however, require such suppliers to abandon such legacy systems in order to gain the anticipated collaborative advantages.

So configured, the various suppliers can readily communicate with the enterprise via the avenue of the extranet 15 and via the auspices of the collaborative supply server 12 and vice versa. In a preferred embodiment, the suppliers do not communicate with one another via this same platform. If desired, however, such a capability could of course be rendered. It should also be understood that the extranet pathway can be secured in various ways as may be appropriate to a given setting. Such security can include the use of password-protected areas and varying levels of encryption as well understood in the art.

In a preferred embodiment, the typical user (both within the enterprise and at the suppliers) will interface with the system via a standard web browser as well known in the art (though if desired, a custom client front-end could of course be defined and built for use by such users). By directing the browser to the collaborative supply server 12, the various capabilities described herein become available. Such an architecture offers a number of advantages, including widespread compatibility for various user platforms as well as the opportunity to offer remote access to users (to accommodate, for example, travelers who wish to remain cognizant of their particular raw materials supply issues).

Merely coupling the various interested parties may facilitate communications between the parties, but of course does not ensure appropriate raw materials supply management. The telephone, facsimile transmissions, and ubiquitous email capabilities all offer a kind of universal communication capability, and such capability has not in the past translated to a desired level of materials supply management. Indeed, it is the capabilities and features of the collaborative supply server 12 that leverages the potential of this shared network to gain the benefits described. (Those skilled in the art will appreciate that the collaborative supply server can be a standalone platform or could be distributed over two or more other platforms, and further, that its functionality could be physically and/or logically parsed over different platforms in a great many ways. Though only a single server is depicted for purposes of clarity and simplicity in these examples, it should be understood that such distributed embodiments are included in the notion of “server” as used herein.)

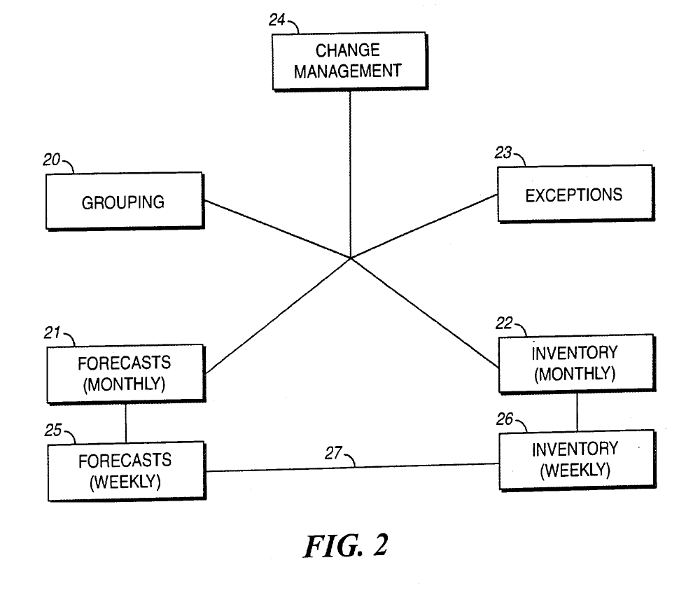

Referring now to FIG. 2, the server 12 supports an interface that essentially permits the user to navigate between five primary task areas: a grouping area 20, a forecast area 21, an inventory area 22, an exceptions area 23, and a change management area 24. These task areas are configured in accordance with well understood prior art techniques to permit direct linking between any of these five task areas. Therefore, for example, one can move immediately from the grouping area 20 to the change management area 24 or to the inventory area 22. Similarly, one can move immediately from the forecast area 21 to any of the remaining four task areas, including the inventory area 22 and the grouping area 20. There are additional areas that can be navigated to via this same common menu, but which exist as sub-items under one of the five main headings. These are listorical Forecast, and Update (or View depending on the users Security level) Tolerances.

Two of these areas, the forecasts area 21 and the inventory area 22, correspond to a monthly view of their respective information. Each of these areas 21 and 22 also links to a weekly view area as well, such that the monthly forecasts area 21 links to a weekly forecasts area 25 and the monthly inventory area 22 links to a weekly inventory area 26. If desired, both of these weekly areas 25 and 26 can link directly (not shown) to any of the other five main areas noted above. In addition, the weekly inventory area 26 can link 27 to the weekly forecasts area 25, but the converse need not be supported.

Other task areas could of course be provided and supported. In one embodiment, a settings task area could be provided on an equal footing with the task areas already described. Such a settings task area could be used to support a variety of tasks, including the setting of default values for a given user and/or the system itself, the setting of rules regarding the making and maintenance of user logs, and security setups. For example, in a preferred embodiment, default values are used for various fields and/or evaluation criteria as used by the system. Such default values can be made viewable via such a settings task area. In addition, at least some of these default values could be made editable (at least within a given range) on a user-by-user basis. In addition, such a settings task area can be used to facilitate other activities, such as the setting of grouping preferences, new resource selections, override lock-out windows, and whatever other parameters or features may be beneficially altered or customized for a given user.

Each of the five main task areas will now be described in more detail.

The Grouping Area 20

In general, the grouping area 20 serves as a convenient way to permit a given user to interact with the system in a fashion that well reflects both the raw materials to be monitored by the user as well as the way that user tends to their business. Such flexibility results in part through a controlled intersection of data regarding raw materials, manufacturer locations and facilities, and individual suppliers. More specifically, the grouping area 20 allows a user to define groups as a function of these parameters and to then use these groups to focus and facilitate interaction with other task areas supported by the system.

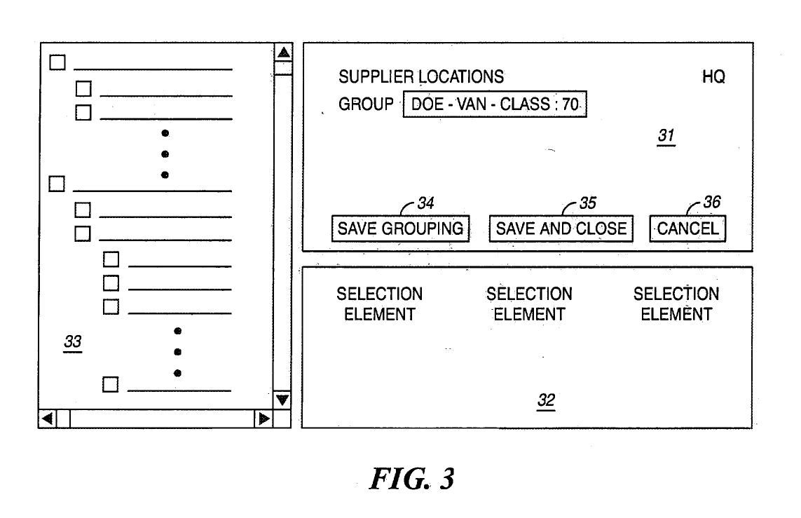

With reference to FIG. 3, a working area includes a parameter palate 31, a details area 32, and a tree components display area 33.

The parameter palate 31 permits selection of specific tree components to be displayed in the tree components display area 33. For example, as illustrated, the “Supplier Locations” option has been selected from the parameter palate 31. As a result, a tree comprising supplier locations has been called up and displayed in the tree components display area 33. In this embodiment, other trees that correspond to packaging materials, raw product materials, headquarters planners (“HQ”), and manufacturer's locations can be similarly accessed and displayed. These trees are used to define groups as described below in more detail. The parameter palate 31 also includes a group name field (“DOE-VAN-CLASS:70” in this example) where the group can be named (or renamed) along with a number of control selections. In a preferred embodiment, the control selections include a first button 34 to permit saving the grouping as presently defined, a second button 35 to permit saving the grouping as defined and then closing this task, and a third button 36 to cancel the definition as built to this point and to delete any grouping that bears the indicated identifier.

So configured, a user can readily and conveniently select trees that present information regarding any of materials, manufacturer's locations, and supplier's locations (along with headquarters planners if desired). These trees, when presented in the tree components display area 33, then facilitate the defining of a group. For example, the user can click on any node to select the corresponding resources and include them within the definition of the grouping then being created. In addition, the user can select a particular degree of gradation or resolution with respect to these nodes. For example, with respect to packaging material, the user can select all packaging materials for a given product, or only the cardboard packaging materials for that product, or only the cardboard packaging materials for that product that have a specific decorative motif Such classes and levels can be created and specified as desired and as appropriate to a given application.

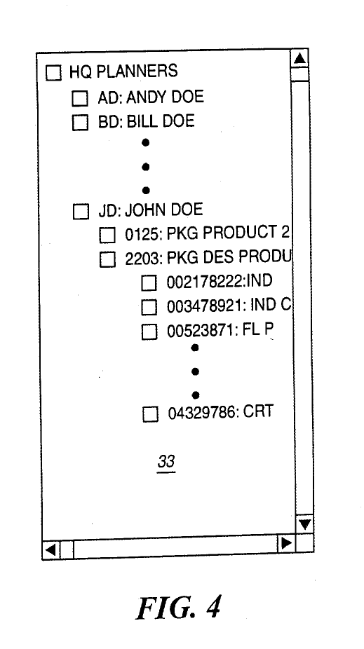

As noted, in addition to specifying a grouping as a function of materials and locations (supplier's and manufacturer's) a user can also use headquarters planners. For example, by selecting “HQ” from the parameter palate 31, a corresponding tree of headquarters planners will be displayed in the tree components display area 33 as shown in FIG. 4. These nodes represent various groupings as have already been established for various personnel within the enterprise. A user could therefore choose to partly define a new group as a function of another individual (such as “JD:JOHN DOE”), a specific grouping as is associated with that individual (such as “0125:PKG PRODUCT 2” or “2203:PKG DES PRODUCT”), or a specific raw material as corresponds to that individual (such as “0021788222” which comprises a unique identifier as used by the enterprise to specify a particular raw material or packaging component).

Referring again to FIG. 3, the details area 32 depicts selections that the user has chosen for the new grouping. Individual elements are added to the details area 32 as described above by making appropriate selections from the tree components. In a preferred embodiment, individual elements can also be deleted from the details area 32 (for example, by highlighting the element to be deleted and selecting the “Cancel” radio button 36, by using the “delete” key on the user's keyboard, or by any other convenient mode).

In a preferred embodiment, there is no upper limit on the number of groups that a given user may define, nor is there any limit to the degree to which such groups may overlap with other previously defined groups. So configured, the groupings area 20 comprises a powerful tool to permit a user to define and shape their system experience to ensure both that they see and have access to the information that they require while also avoiding data that is irrelevant to their responsibilities. One or more groups can be defined at the onset of the user's interaction with the system and groups can be edited, deleted, and added thereafter to reflect changing conditions, responsibilities, and interests.

The Forecast Area 21

A general purpose of this area is to provide a tool to permit validation of direct material forecasts and to make periodic adjustments as required. Beyond this, the area facilitates an ability to share the manufacturer's best possible projections with the suppliers. In a preferred embodiment, the forecast area 21 provides a view to both manufacturer and supplier of forecast information over a twenty-six week window (other durations could of course be utilized to suit the needs of a particular enterprise or circumstance). An optional view permits dissection of the monthly data totals into corresponding weekly totals.

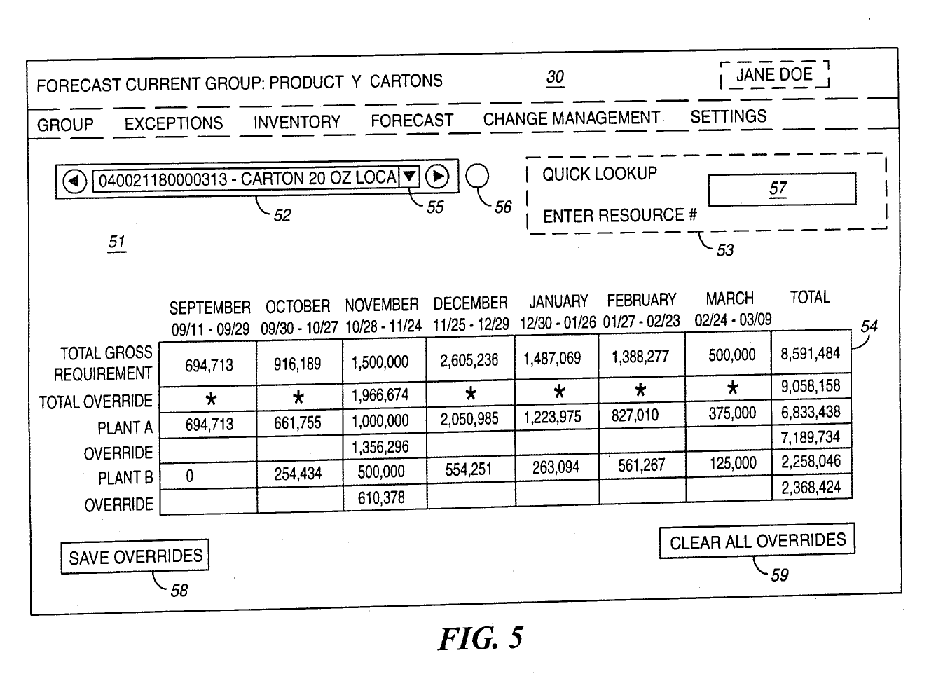

FIG. 5 depicts a typical monthly forecast view in this area 21. As with the grouping area 20, the forecast area display includes a header section 30 that again includes an identifier for the task area itself (“Forecast” in this example) along with a grouping indicator (“Product Y Cartons”, in this example) and the name of the person who has logged on to the system (“Jane Doe” in this example). The header section 30 also again includes the listing of links to all major task areas that are available to the user. The remaining display area 51 includes a resource dropdown/scrolling section 52, a quick resource lookup section 53, and a forecast data presentation section 54.

The resource dropdown/scrolling section 52 displays the current resource being viewed within the selected grouping. The value can be scrolled in marquee fashion to permit viewing all portions of especially lengthy resource values (particularly where, as illustrated here, the resource value includes both a resource identifying number (such as the resource number “040021180000313” as illustrated) and a corresponding text (or otherwise coded) descriptor). A dropdown selector button 55 is used to present additional resource options (wherein the resource options correspond, again, to the group that has been selected). The dropdown selector button 55 can result in either a dropdown (or pop-up) window that presents these resource options and/or scrolling of candidate resource options through the window provided as desired and/or appropriate to a given application. Another radio button 56 associated with this section 52 will link the user to the change management area 24 as described below in more detail. In a preferred embodiment, this radio button 56 is only rendered visible to the user when actual valid effective changes that relate to this resource exist.

The quick resource lookup section 53 provides a convenient mechanism for a user to enter a specific resource number into a corresponding field 57. When using this section 53, other selection dimensions (including, for example, manufacturer and supplier locations) are preset in accordance with preferences as have already been established for this user (or the system) pursuant to the settings mechanism noted earlier. The current grouping will then be changed to correspond to the resource identified in this section 53. Changing the grouping will ordinarily involve a corresponding change to the forecast data that is displayed in the forecast data display area 54. If desired, the resource dropdown/scrolling section 52 can be hidden when a resource has been selected using the quick lookup feature.

The forecast data presentation area 54 comprises a plurality of rows and columns that serve to partition and display forecast information for various facilities as corresponds to various windows of time (in this example, calendar months or fiscal months having a beginning and a conclusion as specified by the manufacturer (for example, in this example, “September” begins on September 9th and concludes on September 29)). In a preferred embodiment, data for a total of seven sequential months are depicted in the presentation area 54. A greater or lesser number of months could of course be accommodated as desired to support a given application. If desired, the particular month to begin the sequence can be made selectable by the user. Such selection could be accommodated in various ways, including by use of a scrolling mechanism, pull-down or pop-up month-selection menus, and/or an entry field to receive the name of a specific month.

A first row in the forecast data presentation area 54 (captioned “Total Gross Requirement” in this example) displays the total supply chain quantity for the corresponding resource (as identified in the resource dropdown/scrolling section 52 described above) by column for the specific time period as identified in the column heading (for example, in this illustration, the individual resource quantity forecasts for the month and column of “October” sum to “916,189”). In this embodiment, a second row in the forecast data presentation area 54 (captioned “Total Override” in this example) displays the total supply chain overridden quantities for this same resource, again by column for the time period specified for that column (for example, in this illustration, the individual overrides for the month and column of “November” sum to “1,966,674”). In a preferred embodiment, a number will only be shown in corresponding fields of this row when an override exists for the time period of that column. When no overrides exist, an asterisk (as illustrated) or other appropriate indicia of this condition serve well to represent this condition (particularly when there are many facilities (and hence many rows) to be displayed).

One or more rows are used to represent forecast amounts for the corresponding resource for parsed and individually identified facilities (for example, in this illustration, two such facilities (“Plant A” and “Plant B”) are shown). In similar fashion, another row (labeled “Override” in this illustration) is paired with each facility row to display the overridden quantity by column for each corresponding facility. While the other fields in the display area 54 are, preferably display-only fields, these override fields can be rendered as input fields (at least under some operating conditions as appropriate to a given application) to permit override data to be entered and/or edited by a user when viewing this task area 25. In a preferred embodiment, when no override data has been entered into a given override field, the system will presume that zero overrides are intended. Note also that, if desired, negative numbers can be permitted as valid override entries to suit corresponding forecast conditions.

A “Save Overrides” radio button 58 saves any changes entered with respect to the override data back to the system. In addition, if desired (and as generally described in more detail below), a days forward coverage calculation can be automatically launched and days forward coverage information as displayed at the inventory area 21 can be updated accordingly. Another radio button 59 serves to “Clear All Overrides” that will, as suggested, clear all override data for the identified resource. Again, automatic initiation of the days forward coverage calculation can be supported. If desired, standard confirmation techniques can be used to test the user for confirmation that such clearing is indeed presently intended before actually clearing the override information for this resource.

The month-by-month parsing of this forecast information over the various columns will be adequate to many (or all) associated needs of many enterprises. In some instances, however, it may be desirable to provide information with finer granularity. To accommodate such a need, the date range for each column (for example, the date range “12/30-01/26” for the month of “January”) can itself comprise a link. When selected by a user, the link can take the user to a display (such as the weekly forecast display 25 depicted in FIG. 2) that could be, for example, essentially as shown in FIG. 5 except that the columns would represent the various weeks (or days or other windows of time as desired by the user) that correspond to the date range that was selected in the monthly view described above. So configured, the same kinds of individual facility forecasts and overrides and total forecasts and overrides as presented above can be similarly presented on a weekly (or other pertinent interval) basis.

When providing the opportunity for increased granularity as just described, overrides as entered (or edited or removed) at the weekly view should be automatically reflected at the monthly view as well. Similarly, overrides entered (or edited or removed) at the monthly level should be automatically reflected at the monthly view. In a preferred embodiment, monthly override amounts can be evenly distributed over the weeks (or other time period) that correspond thereto. When the quantity does not divide equally, the remainder can be assigned, for example, to a particular one of the weeks.

In a preferred embodiment, the forecast data as made available to a supplier may be restricted to accord with the legitimate interests of the supplier. Similarly, if desired, the totality of forecast data as may be available to a given employee of the manufacturer can also be restricted where appropriate. Also, the ability to enter, change, or clear overrides may be restricted to only particular users using known security and control techniques.

The Inventory Area 21

A general purpose of this task area is to provide a projected view of inventory to allow a user to view the manufacturer's, supplier's, and supply chain inventory for a given resource over a predetermined period of time (such as a six month period of time). This task area uses the concept of days forward coverage to facilitate meaningful use of the data presented. The days forward coverage parameter, in general, aids in understanding the extent of time that a given quantity of inventory will persist from a particular beginning point in time. Such calculations can also be used, in a preferred embodiment, to compare against application tolerances to support exceptions generation as described below in more detail.

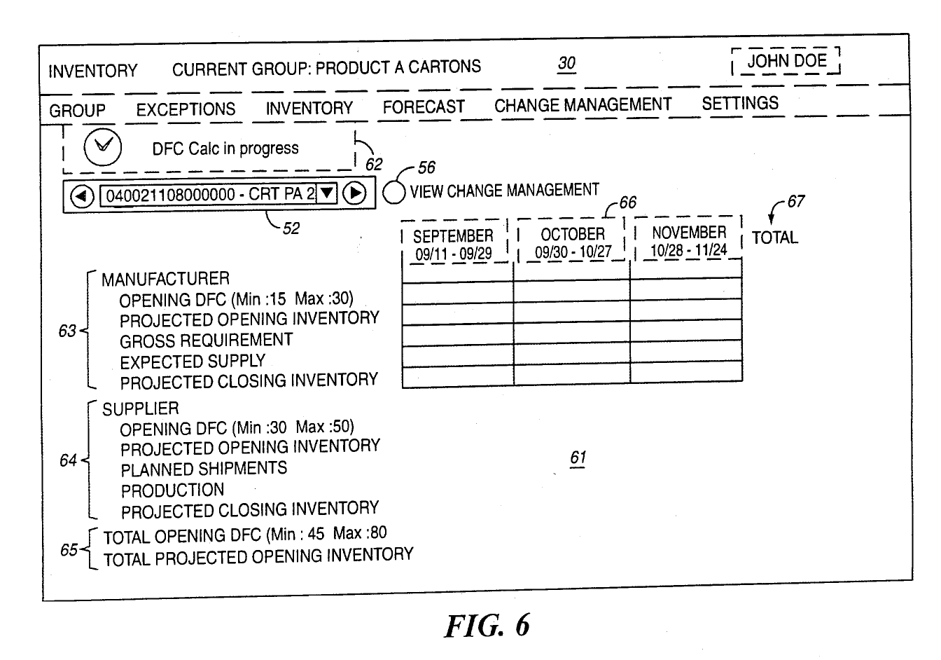

Referring now to FIG. 6, the inventory area 22 includes, in a preferred embodiment, a monthly view that again includes the common header format 30 having a display area 61 disposed there beneath. One section 62 of the display area 61 serves to provide, in a preferred embodiment, an indication of when a days forward coverage calculation is presently in progress. Since such a calculation (and the re-population of affected fields with corresponding altering information) may, under some circumstances, consume a noticeable amount of time, this indicator can help a user avoid mistaking a lack of immediate change to relevant data for a system failure or user error. Another section 52 of the display area 61 can also again be used to provide a resource dropdown/scrolling section as described above.

The bulk of the remainder of the display area 61 serves to present, using a month-by-month column-based format, days forward coverage information and corresponding data for the manufacturer, supplier(s), and aggregate party totals. In a preferred embodiment, six months are so displayed. As illustrated, however, only three months are depicted for purposes of clarity and brevity. It should be understood that the number of months so represented can vary to match the needs of a particular application. It should also be understood that periods of time other than months could be accommodated as desired.

A first section 63 of the display area 61 provides such information for the manufacturer, a second section 64 provides such information for the supplier (or suppliers), and a third section 65 provides aggregated totals that correspond to both the manufacturer and the supplier(s). In addition to depicting information on a monthly basis 66 for each such category, an aggregate total 67 for each such category will also be presented in a preferred embodiment.

In the first section 63 as provided for manufacturer information, a first row (captioned “Opening DFC” in this example) presents the opening days forward coverage value for each month indicated. These values are calculated as follows:

Inventory is begun at a specified quantity as provided in the “Projected Opening Inventory” field for each month (if and when this value is negative, the corresponding days forward coverage value is preferably set to zero);

The gross requirements (that is, the projected quantity of the item to be used or consumed) value as provided in the “Gross Requirement” field for each month is then repeatedly subtracted from the above value until the remaining quantity becomes zero or negative;

At the enterprise level, the days forward coverage value then comprises the period of time that corresponds to the duration between the inventory at a given start date and the date that corresponds to the point where the cumulative gross requirement values results in a zero or negative subtractive result—when a negative result occurs a decimal value equal to the partial coverage value and attempted subtraction amount is presented;

At the supply chain level, the days forward coverage takes a combined view of opening inventory of both the enterprise and the supplier on a given day and applies the gross requirement values in the same manner as described for the enterprise level,

Finally, in this embodiment, at the supplier level the days forward coverage value is the difference between the supply chain and enterprise values.

A minimum/maximum concept can be applied to the exception logic as well. The exception logic makes use of tolerance values (such as the minimum value of “15” and the maximum value of “30” as appear in the information 63 that pertains to the manufacturer) as are set, for example, by materials managers based on their knowledge of the business. An exception may then be triggered based on these settings when:

The days forward coverage calculation falls below such a minimum tolerance.

The days forward coverage calculation falls above such a maximum tolerance.

- -

-

The projected opening inventory value noted above generally represents, in a preferred embodiment, the beginning inventory of the relevant time period. As a result, in general, the projected opening inventory value for any month other than the first month will typically equal the projected closing inventory value for the preceding month. The projected opening inventory value for the first month can usually be established as the inventory balance then actually on hand.

The gross requirements value noted above generally represents, in a preferred embodiment, the accumulation of such requirements across selected locations that carry the selected resource for the column date range. As noted earlier when describing the forecast task area 21, requirement overrides can be entered by at least some users under at least some circumstances as established and permitted by the system. Such override values can be accumulated and used where appropriate to contribute to the corresponding gross requirements values. When overrides contribute to the value of a particular gross requirements value, if desired, a particular unique corresponding override indicia (such as a colored font or a unique font type) can be used to highlight that particular gross requirements value as representing, at least in part, override information. To the extent that such an indicia is provided, the inclusion of that indicia may be provided or withheld as a function, if desired, of whether the user is the manufacturer or a supplier (for example, it may not be desired to provide such indicia to some or all suppliers).

The expected supply value noted above generally represents, in a preferred embodiment, the accumulation of one or more kinds or classifications of supply types. For example, where appropriate to a given enterprise, both committed quantities (as reflected, for example, in executed or otherwise processed purchase orders) and planned replenishment quantities can be summed to yield a corresponding expected supply value.

The projected closing inventory value for the manufacturer comprises, for each column, the projected opening inventory value for that column plus the expected supply value for that column less the gross requirements value for that column.

The supplier section 64 of the display area 61 includes similar categories of information that pertain to the supplier's participation in the supply chain (again, if desired, the supplier section 64 can represent information for a single supplier or can provide aggregate information for a number of suppliers that are all supplying the selected resource). In particular, a similar projected opening inventory row provides monthly supplier information substantially as described above for the manufacturer. In addition, a “Planned Shipments” row corresponds to the supplier's side of the Expected Supply information for the manufacturer. For purposes of automated calculations, unless the supplier indicates otherwise, the planned shipments value is assumed to be the same as the expected supply values as entered for the manufacturer.

A “Production” row displays values that represent, in a preferred embodiment, in-process materials, firmed materials, and planned materials. In-process materials comprise production quantities that are already being produced by the supplier. Firmed materials comprise production quantities that are not yet being produced but for which the supplier has procured the necessary materials and/or has scheduled the necessary workers. Planned materials comprise quantities that are planned but for which the supplier has yet to significantly change its position with respect to materials requisitions and/or labor dedication. A “Projected Closing Inventory” row comprises a value that represents, in a preferred embodiment, the projected opening inventory value as summed with the production value less the planned shipments value.

As with the manufacturer's information 63, the supplier's information 64 includes an opening days forward coverage row. This value is calculated for the supplier in an identical fashion as for the manufacturer, except, in a preferred embodiment, for using the projected opening inventory value from the supplier's row rather than the manufacturer's information area.

A third section 65 provides totals that represent a summing of the manufacturer and supplier information as is provided above. Note that in a preferred embodiment, the minimum and maximum tolerances are calculated by summing the corresponding tolerances for both the manufacturer and supplier sections (for example, the minimum tolerance of “15” for the manufacturer is summed with the minimum tolerance of “30” for the supplier to obtain a minimum tolerance of “45” for the combined total).

As with the forecast task area, inventory views can be provided with finer granularity as regards the time frame. Again, the column-by-column time duration can serve as a link to provide a parsed view of that time duration over, for example, a plurality of weeks that, in aggregate, equal the selected time duration. The same information as is provided for the monthly view can be provided for the week-by-week view with the values being parsed accordingly.

In a preferred embodiment, and unlike the forecast task area 21, the inventory information displayed by column and row in the inventory task area 22 is all display-only. As a result, a user can view this information but cannot effect changes to the data from this area.

As described above, the information provided represents an aggregate view of all manufacturing facilities and/or all relevant suppliers for a given selected resource. If desired, additional screens can be provided to permit a similar view of the individual contribution of each facility and/or supplier.

So configured, these two areas (the forecast area 21 and the inventory area 22) permit general and/or specific views of materials needs forecasts and materials inventory as pertains to both the manufacturer (at all relevant locations) and relevant suppliers for a given resource (i.e., a particular raw material or packaging element). Further, these task areas facilitate the calculation of important values, including the days forward coverage values, that offer important potential insights into the relationship and balance between the usage and needs forecasts of the manufacturer and the available inventory of the corresponding material. Such information, while significant and potentially potent when supporting a skilled materials manager under at least some operating conditions, nevertheless does not necessarily prompt a sufficiently increased collaborative relationship between the manufacturer and suppliers and/or facilitate greater reliability and ease of the management process. In at least some embodiments, the exceptions area 23 and/or the change management area 24 described below serve to further leverage the potential of the forecast and inventory information so provided and/or developed.

The Exceptions Area 23

Some materials and resource managers, particularly in a large enterprise, have active responsibility and/or interest in hundreds of individual resources. Reviewing all supply chain information (such as, for example, inventory and forecast information) for all individual resources of interest on a frequent basis can therefore present a formidable cognitive and logistical challenge. The exceptions area 23 serves to facilitate the reviewing and monitoring process by aiding with the ascertainment and presentation of exceptions within the supply chain. In other words, the exceptions task area 23 aids in helping to focus the attention of the manager on those specific matters that genuinely appear to require or deserve such attention.

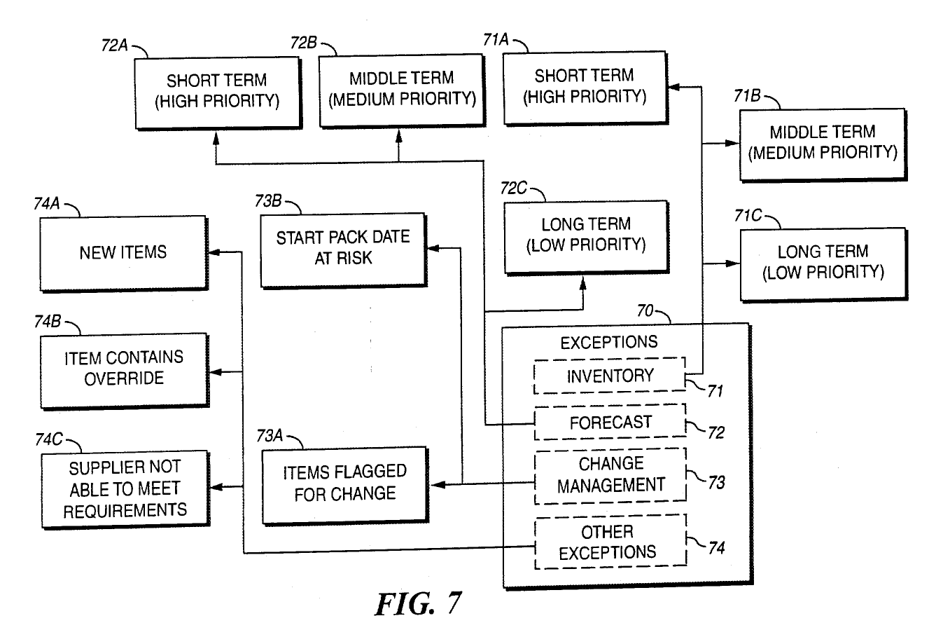

Pursuant to a preferred embodiment, exceptions are identified with respect to four main categories: inventory, forecast, material change management, and a miscellaneous category. In addition, and again pursuant to a preferred embodiment, exceptions within each category can be ranked to thereby prioritize the exceptions with respect to the user's criteria of importance or need for attention. FIG. 7 illustrates this general approach.

As shown in FIG. 7, the exceptions area 70 tracks exceptions for 4 separate categories: inventory 71, forecast 72, change management 73, and other exceptions 74. Exceptions for the inventory category 71 are in turn parsed by temporal considerations, such that short term inventory exceptions 71A are categorized as being of a highest priority, middle term exceptions 71B are categorized as being of a medium priority, and long term exceptions 71C are categorized as being of a low priority. In a similar fashion, the forecast exceptions 72 are categorized as being of high priority 72A, medium priority 72B, and low priority 72C as a function of time. Other criteria could of course be used to prompt such prioritization (such as, for example, the relative quantities involved, the importance of the corresponding product to the market, the image of the enterprise, and so forth). In additional, a greater or lesser number of prioritized categories could be used to accommodate the needs and/or processes of a given enterprise.

The change management category 73 is parsed as between items that are flagged for change 73A and situations that denote a risk to the start date for a given package 73B. These concepts will be discussed more below. The other exceptions category 74 can encompass whatever issues or parameters may be relevant to a given application. In a preferred embodiment, three main exception areas are tracked: new items 74A, items than contain an override 74B (such as a forecast override as described above), and situations where the supplier is not able to meet requirements.

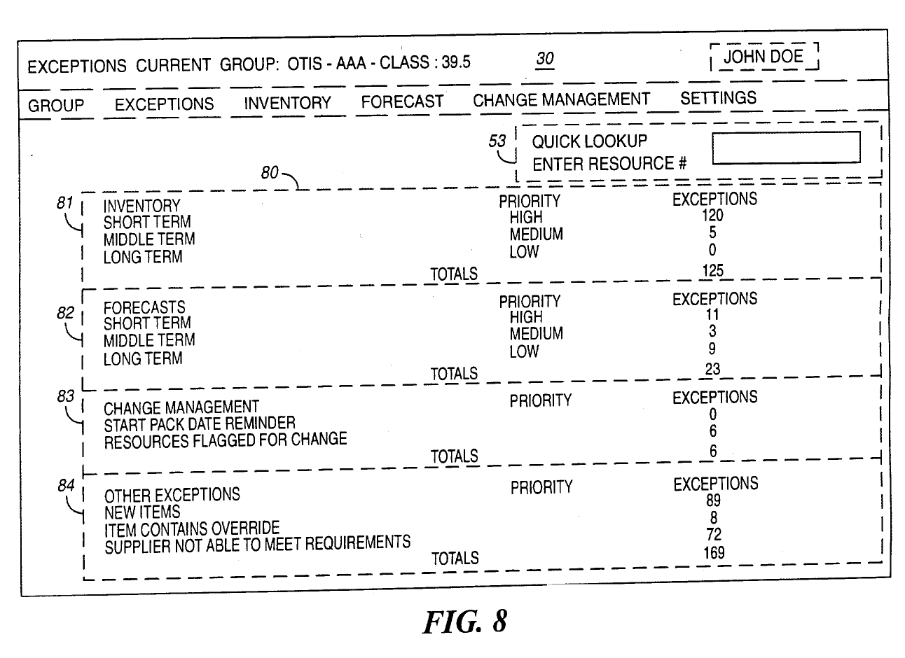

Referring now to FIG. 8, an illustrative entry screen for the exceptions area 23 will again, in a preferred embodiment, maintain the same general look and feel as entry screens for the other task areas discussed above. This includes a header section 30 as generally described above and a resource dropdown/scrolling section 52 as also described above. The remainder of the display area comprises an exceptions information display area 80 where separate areas 81, 82, 83, and 84 are provided for inventory, forecasts, change management, and other exceptions information. Each separate area uses column and row displays to present the number of exceptions that presently exist for each parsed category. For example, in the inventory separate area 81, a descriptor “Short Term” is matched by row with the priority level “High” and a corresponding number of current exceptions for this parsed category (in this example “120” means that there are 120 separate exceptions that are categorized as being within a short term and hence being of a high priority). The duration of these priority-defining windows can be set as desired by a given enterprise. As an example, a short term could equate to zero to five weeks, a medium term could comprise six to twelve weeks, and a long term could represent any longer durations.

Again, exceptions can be whatever a given user defines them to be, but in general and in a preferred embodiment will tend to be instances where input or calculated values for different tracked items or concepts are outside of some pre-established normal range for such parameter. For example, as illustrated, both the inventory and forecast entries for each resource item have a calculated days forward coverage value calculated therefore. Each such days forward coverage value can have a corresponding minimum and maximum value that represents a normal (or otherwise acceptable) range. When the days forward coverage value is less, or greater, than this range, an exception can automatically be noted and tallied for representation via the exceptions task area 23. Exceptions for other values can also be noted as desired. For example, exceptions can be correlated to sudden changes in requirements forecasting or material change management activities as well. In the example provided, there are eleven such exceptions in the forecast display area 82 that represent short term conditions and three such exceptions that represent middle term conditions.

The change management display area 83 serves to provide information, in this embodiment, with respect to start package date reminders and resources that are flagged for change. The date reminder exception is preferably generated automatically when the start package date for production falls within a timeframe that has been determined by the user (and/or which has been established as a default setting within the system). The flagging category is preferably generated automatically when the change management facility has been used to establish the transition of a resource.

The other exceptions display area 84 serves to provide information, in this embodiment, with respect to new items, items containing an override, and situations where a supplier cannot meet a particular requirement. The new items category can be used to highlight new resources as they become defined and active within the system thereby permitting the manager to remain cognizant of such developments. The override category simply reflects exceptions that are automatically generated when a forecast override is applied to an item. So configured, overrides as entered by others can be monitored as desired and, when necessary or appropriate, modified or challenged as per the appropriate internal processes of the enterprise. The supplier category can be used to reflect instances where the input supplier commitment to provide a given resource nevertheless results in a shortfall with respect to expected net requirements for that resource.

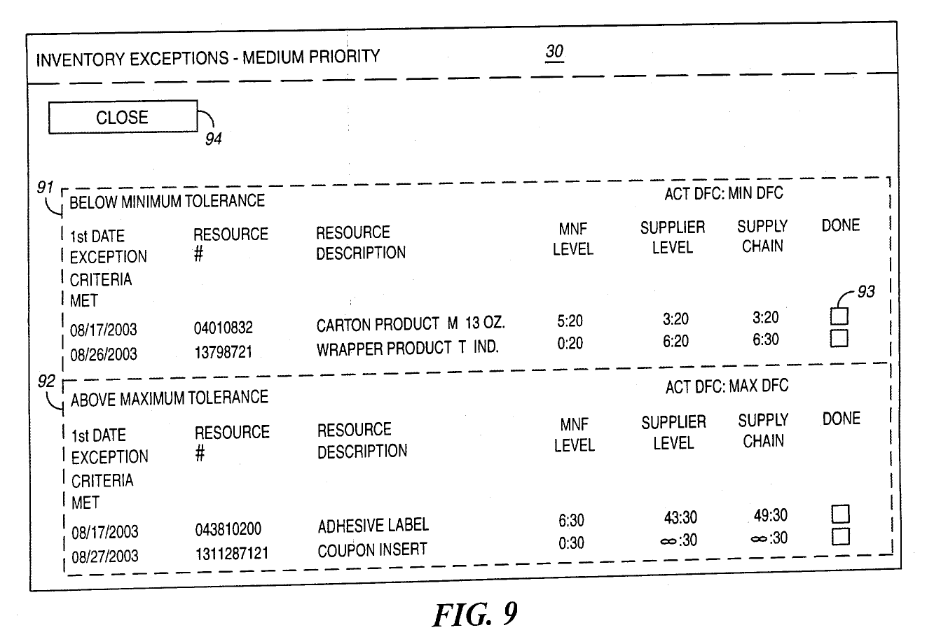

In a preferred embodiment, the fields described above are display-only and do not permit a user to effect changes or editing with respect to the information provided. Also in a preferred embodiment, however, variations of these labels and/or displayed values can serve as links to permit a user to obtain deeper and more detailed information with respect to any of the categories or values shown. For example, the “Middle Term” descriptor in the “Inventory” display area 81 could be selected by a user and a corresponding interface brought to the fore. For purposes of illustrating this feature, FIG. 9 depicts a sample screen that could be provided in response to such a user selection.

The screen for the “Inventory Exceptions—Medium Priority” can lead, in a preferred embodiment, to a display of information that is partitioned as appropriate to the nature of the information itself. For example, as described above, the days forward coverage values for a given resource can constitute an exception by being either above a maximum tolerance or below a minimum tolerance. Therefore, this screen includes a first area 91 to support the display of exceptions that are below the minimum tolerance for the relevant days forward coverage values and a second area 92 to support the display of exceptions that are above the maximum tolerance for the relevant days forward coverage values. (In keeping with the look and feel of the user experience described above, a detailed view such as this one also includes the informative header 30.)

A row and column format is used to correlate various items of information. On one side of the first and second display areas 91 and 92, the resource identifier (“Resource”) and resource description (“Resource Description”) are provided along with a field that identifies the first date when the exception criteria for this particular resource was first met. Although the exception criteria may have been met on subsequent days, usually the initial beginning of the exception event holds more informational import for many managers. If desired, the date provided can constitute a link that the user can select to access a display of the intervening days along with an indication of which intervening days also incurred the same exception.

On an opposing side of the display 91, values are provided to indicate actual days forward coverage values and the corresponding minimum days forward coverage values for each of the manufacturer (“MNF Level”), the supplier (“Supplier Level”), and the supply chain (“Supply Chain” which, in this embodiment, represents the sum of both the manufacturer's values and the supplier's values). For example, in the illustration provided, the actual days forward coverage value for the manufacturer for resource number 04010832 is “5” and the target days forward coverage value is “20.” If desired, only information that corresponds to an exception need be displayed. For example, if an exception exists only at the supplier level, then only supplier level data need be displayed to minimize the user's cognitive loading. A similar convention is applied in the second display area 92 to facilitate the display of exceptions that represent conditions that exceed a maximum days forward coverage tolerance.

In a preferred embodiment, an additional column 93 captioned “Done” or the like provides a checkbox or other similar interface for each resource/row. Through this mechanism, a given user can enter a check in the checkbox for each row that the user has considered. Such an indicia can be used by the system to, for example, clear the exception at least prior to the next day's exception calculation processing. So configured, the detailed exceptions screens effectively serve both to provide information and to function as something of a to-do list for the manager. In addition, a “Close” radio button 94 is provided to facilitate closure of the detailed exceptions view (in general, such detailed views as provided within the exceptions area 23 are, preferably, not provided with links to other areas, in part because there are no intuitive and unambiguous analogues to this level of information in those other areas. If desired, however, such links could be provided as well understood in the art.

FIG. 9 presented the example of a detailed screen for inventory exceptions of medium priority. Similar screens can be readily provided for the priority levels and also for each of the other exceptions categories (for example, a similar detailed screen can be provided for forecast exceptions of high priority as well as for change management exceptions regarding resources that are flagged for change). For the sake of brevity and clarity redundant examples of such screens are not presented here.

If desired, the exceptions area 23 can be configured to automatically forward a message, such as an email, to one or more individuals whenever an exception occurs (or at least when exceptions having more than a threshold level of priority occur). For example, such emails could be automatically sent to relevant suppliers and/or to users who include the impacted resource within one of their defined groups. this mechanism, a given user can enter a check in the checkbox for each row that the user has considered. Such an indicia can be used by the system to, for example, clear the exception at least prior to the next day's exception calculation processing. So configured, the detailed exceptions screens effectively serve both to provide information and to function as something of a to-do list for the manager. In addition, a “Close” radio button 94 is provided to facilitate closure of the detailed exceptions view (in general, such detailed views as provided within the exceptions area 23 are, preferably, not provided with links to other areas, in part because there are no intuitive and unambiguous analogues to this level of information in those other areas. If desired, however, such links could be provided as well understood in the art.

FIG. 9 presented the example of a detailed screen for inventory exceptions of medium priority. Similar screens can be readily provided for the priority levels and also for each of the other exceptions categories (for example, a similar detailed screen can be provided for forecast exceptions of high priority as well as for change management exceptions regarding resources that are flagged for change). For the sake of brevity and clarity redundant examples of such screens are not presented here.

If desired, the exceptions area 23 can be configured to automatically forward a message, such as an email, to one or more individuals whenever an exception occurs (or at least when exceptions having more than a threshold level of priority occur). For example, such emails could be automatically sent to relevant suppliers and/or to users who include the impacted resource within one of their defined groups.

So configured, the exceptions area 23 serves to collect exceptions (as defined by the enterprise/user) and to display the existence and nature of such exceptions at varying levels of informational content, ranging from an overall statistical view to the specific details as pertain to each individual impacted resource. By using this task area 23, a user can quickly ascertain the number and relative impact of exceptions as have been automatically noted on any given day. The user can also easily and relatively intuitively drill down to detailed information regarding such exceptions to facilitate both understanding each situation and the taking of corrective action. In some cases, the appropriate corrective action requires user actions that are external to the system environment. In many cases, however, the user can facilitate corrective action (or prophylactic action) via the system by using the change management area 24.

The Change Management Area 24

In general, this task area 24 serves to provide materials management personnel with an integrated tool to facilitate the management of changes with respect specifically to resources and more generally to the supply chain. This task area 24 supports such capability, in part, by providing two-way communications between the manufacturer and the suppliers with respect to such changes. Another capability offered by this task area 24 is the ability to automatically divert forecasted requirements from one resource to another based on configurations provided by material management. (It should be noted that, in this embodiment, such alterations to forecasting information are not also automatically reflected back to the legacy forecast data system 13 (as referenced in connection with the description of FIG. 1). Instead, the present system serves to receive and to thereafter use modified forecast information even when such modifications then conflict with data from the legacy system 13. Eventually the data in the legacy system 13 will be brought current through whatever processes the enterprise ordinarily uses to effect such updates. If desired, of course, the system could be configured to effect such updates automatically.)

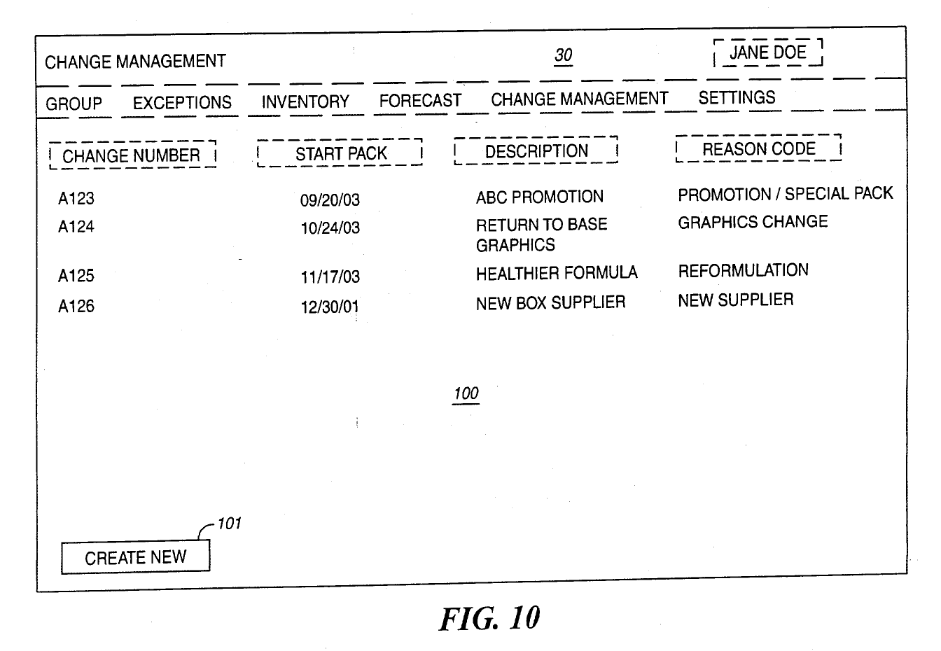

Referring now to FIG. 10, a list change number screen comprises one convenient way to access the change management area 24. This screen again includes the usual header information 30 and again presents a display area 100 where pertinent information is displayed. For this screen, the display area 100 presents rows of change management data that are each comprised, in this embodiment, of four information fields. These fields are a “Change Number” field, a “Start Pack” field, a “Description” field, and a “Reason Code” field.

The “Change Number” field sets forth the change number as has been assigned within the system to a particular change management item. Preferably, these change numbers are automatically assigned in sequential order at the time of creating a change management item. The “Start Pack” field sets forth the scheduled date for the change management item to become active. The “Description” field provides a free text description of the change management item and, in a preferred embodiment, comprises information as entered by the user who initially established the change management item. Lastly, the “Reason Code” comprises a text field that sets forth a specific selectable text code that represents the category within which the change management item falls. These allowed categories and the corresponding text code can be as desired to reflect the needs of a given enterprise. So, for example, in the illustration provided, change number “A125” refers to a change that is to be implemented on Nov. 17, 2003 and relates in general to a reformulation of an existing product and more specifically to a healthier formula.

Only four change management items have been depicted for purposes of brevity and clarity. It should be understood that hundreds or thousands of such items can be included. Scrolling buttons can be added to facilitate the navigation of additional change management items and/or other search mechanisms could readily be provided in accordance with well understood prior art technique.

As mentioned above, a change management item exists because a material manager or other user has created it. To facilitate such creation, a “Create New” radio button 101 can be provided to bring up a window or other display to elicit the appropriate information for a new change management item. In general, any number of change management items can be created and tracked by a given enterprise. In this embodiment, the change management items comprise alterations to a resource. These changes can include stopping or starting production of a product or particular packaging form factor, changes to the existing packaging of a product, and changes to an existing product itself. Therefore, for example, a date can be assigned to a first resource to indicate the date by when consumption of that material should be at least substantially concluded and another date can be assigned to a second resource to indicate the date by when consumption of that material is scheduled to begin. As already noted, resources can be correlated to one another. Therefore, in a preferred embodiment, when a first resource is scheduled to begin on a particular day, a conclusion date can be automatically calculated and scheduled for a second resource that is appropriately correlated to the first resource. For example, if the first resource (such as a new package) is scheduled to begin usage on March 15 of a given year, a second resource (such as a package to be retired) that is appropriately related to the first resource via the change management area 24 can have a retirement date of March 15 automatically assigned thereto.

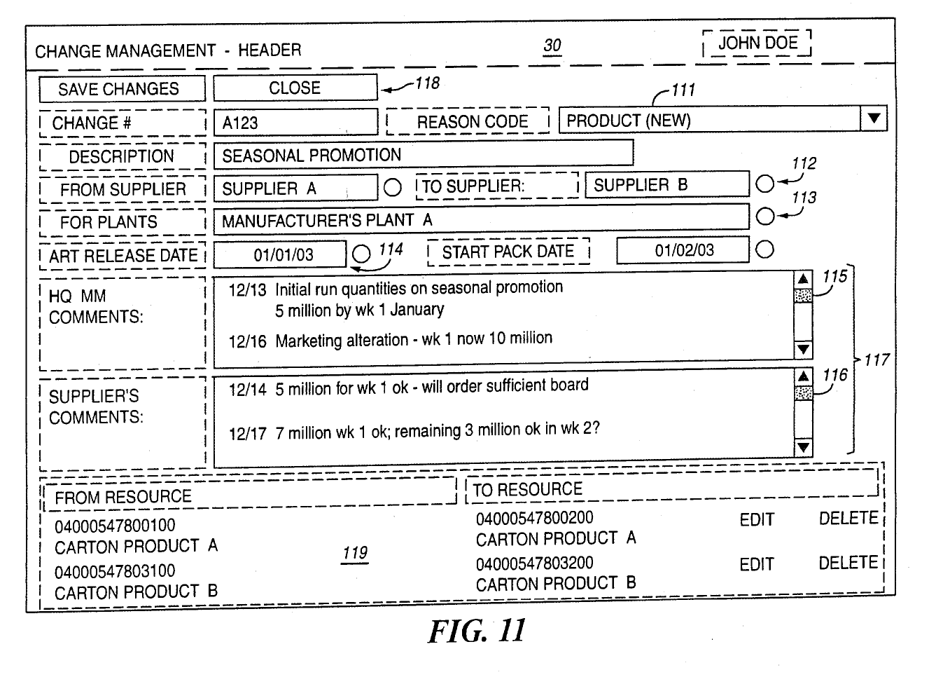

The change number can itself constitute a link to lead the user to a display screen that sets forth more detail regarding that particular change number. For example, referring now to FIG. 11, a change management detail display can set forth considerable information regarding the resource, the changes to the resource, relevant dates concerning aspects of the change, and interested and/or affected parties. Unlike the list change number screen described with respect to FIG. 10, where the information was all set forth as display-only information, the information as set forth in the detail screen can, for the most part, be altered and edited by an authorized user. One possible exception would be the “Change #” field—once a change number has been assigned by the system, that number should preferably remain unaltered thereafter by the user.

As noted above, the “Reason Code” for a given change management item is selected from a predetermined list of system acceptable text codes (in this example, “Product (new)”). The display field 111 for this information can be made scrollable in accordance with well understood prior art technique to render all system acceptable text codes visible for selection by the user.

Some change management items may involve the transfer of materials sourcing, in whole or in part, from one supplier to another. A row of data entry fields 112 can be provided to select the “From” and “To” suppliers to accommodate such a circumstance. In a preferred embodiment, a look-up button can be provided for both “From” and “To” supplier identification fields to permit the user to access a list of predetermined suppliers. This data integrity aid will help in assuring that each supplier is both known to the system and that the supplier is identified in a consistent manner throughout the system.

In many instances, a given change management item will involve one, many, or all of the manufacturer's facilities. A data entry field 113 is provided to permit corresponding selections. Again, a look-up button can be provided to preferably permit the user to select one or more (or “ALL”) facilities from a predetermined and pre-approved list of such facilities.

In many instances, a given change management item will involve new or altered packaging. An “Art Release Date” field can be provided in a preferred embodiment to permit entry and tracking of the date by when the artwork for such new or altered packaging is to be released for use. A look-up button can be provided to permit calling up a calendar to facilitate selection of an appropriate date.

In addition to the above, data entry fields for “Description” information and “Start Pack Date” information as described earlier are also provided to permit entry or modification of previously entered information regarding such items.

The above data entry fields permit entry of various kinds of relatively objective information regarding a change management item. By providing at least selective access to such screens to suppliers, a manufacturer and one or more suppliers can readily communicate with one another regarding such information. In addition, however, the change management task area 24 also provides a text-based communications area 117 that is, in this embodiment, comprised of a first discrete communications area 115 and a second discrete communications area 116. The first communications area 115 comprises an area where text messages from manufacturer's materials managers can be entered and then read by the supplier and others within the manufacturer's organization. In a preferred embodiment, all such messages are retained (at least for some period of time) in sequential order. A lengthy list of such messages can be viewed, if desired, by providing scrolling controls as well understood in the art. In a similar fashion, the second communications area 116 comprises an area where text messages from the supplier can be entered and then read by the manufacturer.

So configured, specific or general text messages can be entered and reviewed by both parties. These text messages can include questions that are posed to the other party and/or answers that are being presented to questions that have been raised by the other party. In a preferred embodiment, dates are automatically added to each message when entered. Such date stamps, when present, aid in establishing the sequence in which a two-way dialogue should be reviewed.

In a preferred embodiment, “Save Changes” and “Close” radio buttons 118 are provided to permit a user to save edited information and/or the entry of new information in the above fields and/or to leave the display without effecting any permanent changes to the data.

Also in this embodiment, another display area 119 comprises a resource modification selector section and is used to display the resource numbers (and corresponding resource descriptions) that are impacted by the change, number being displayed above. This will typically include anywhere from one resource number to a large number of resource numbers. When a large number of resource numbers are included, a scrolling mechanism can be provided in this display area 119 to permit full access and viewing by the user.

As noted above, one resource can be correlated to another via the change management area 24. This section permits a view of such relationships. The “From Resource” side of the display generally indicates resources that are about to be transitioned to a new resource (or a modified resource) while the “To Resource” side of the display generally indicates the resources that are scheduled for future usage in lieu of the previous resources.

Changes made via the data entry fields noted above will typically affect each resource set forth in this display area 119. There may be times, however, when not all resources should be identically impacted or scheduled. To permit higher resolution change management, an “Edit” and “Delete” capability is provided for each separately listed resource. The “Delete” selection will simply remove the corresponding resource(s) from the list change management list. In a preferred embodiment, one or more security steps may be introduced at this point to ensure that the user genuinely intends to remove the resource from the change number.

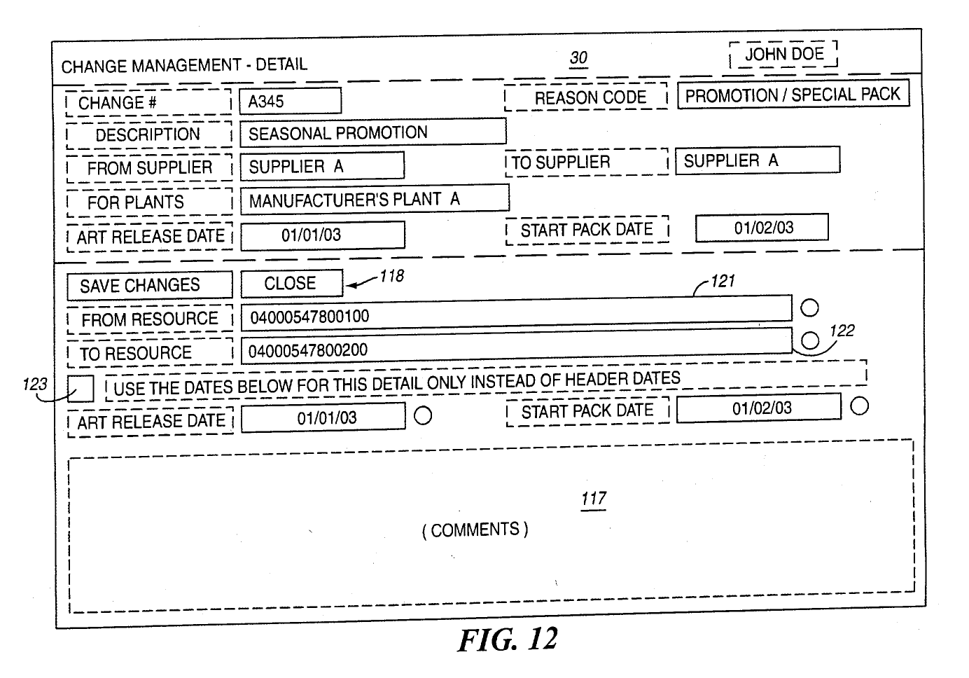

When the “Edit” selection is made, a change management detail screen is called up such as the one depicted for purposes of illustration at FIG. 12. In this mode, information can still be viewed regarding any of the reason codes, the description, the relevant suppliers, the manufacturer's plants, art release dates, and start pack dates. In addition, specific information can be entered or altered with respect to the existing resource number 121 that is going to be changed as well as the resource number 122 (which many times will be a new resource number reflecting, for example, a new package) that is going to replace the existing resource number 121. In a preferred embodiment, look-up buttons are provided to permit all candidate resource numbers to be viewable.

As with the main information page described at FIG. 11, the detail page includes data display and entry fields for the “Art Release Date” and “Start Pack Date” information. In a preferred embodiment, however, a selection box 123 is also provided at the detail level to permit the user to determine whether these dates as set forth on this detailed view are to impact only the specific resources noted on this detailed view or all resources that are linked to the change number.

Also as with the main information page described at FIG. 11, a comments area 117 and “Save Changes” and “Close” radio buttons 118 are provided as well. In a preferred embodiment, the comments entered by either manufacturer or supplier in the comments area on the detailed display will appear only on the detailed display. If preferred, however, in an alternative embodiment only comments that were entered via the detailed screen are viewable at the detailed display level while all comments are viewable at the main information page.

The change management area 24 can therefore be seen to be a powerful tool for facilitating changes and for noting, reacting, and managing changes as they occur. In particular, changes made with respect to resources (such as, for example, resources to be retired) will often result in necessary changes to forecast information for that resource. The change management area 24 can serve to automatically modify inbound supply chain forecast information for such a resource and reflect that modification throughout the other task areas (as noted, this prompt action can well precede any updating of such information in a standalone forecast data memory as may also be used by the enterprise).

So configured, this system permits great flexibility to accommodate a wide range of enterprise activities in a highly collaborative working environment with suppliers and others working within the enterprise. The system will automatically track, as frequently as the enterprises wishes to provide, a wide range of supply chain information and provide notice to users who have indicated an interest in resources that are being impacted. Potential problems can often be identified and therefore resolved before they become actual problems. Changes can be effected in a fashion that ensures both that the changes will occur as per a desired schedule while simultaneously assuring that existing inventories are appropriately depleted prior to the change. Access to these features is convenient and readily intuitive. Access can be assured both to remote users and suppliers as well (virtually regardless of what legacy system the supplier may be using).

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method for use by a manufacturer and a plurality of suppliers to facilitate a collaborative supply of materials from the suppliers to the manufacturer, comprising:
presenting upon demand by any of the manufacturer and the plurality of suppliers an integrated change management display comprising:
an identification of at least one specific material to be supplied by at least one of the plurality of suppliers to the manufacturer;
a date selector to facilitate selection and display of a date by when consumption of the at least one specific material by the manufacturer is scheduled to begin;
at least one comments area where change management comments from the manufacturer and the plurality of suppliers can be entered and displayed;
a resource modification selector section where the at least one specific material to be supplied can be correlated with at least one prior material, wherein completion of consumption of the at least one prior material by the manufacturer prior to beginning consumption of the at least one specific material is desired;
using the integrated change management display to facilitate automatic modification of inbound supply chain forecast information of the at least one prior material.

2. The method of claim 1 wherein using the integrated change management display includes automatically scheduling a date by when consumption of the at least one prior material should be at least substantially concluded as a function of the date by when consumption of the at least one specific material by the manufacturer is scheduled to begin.

3. The method of claim 1 wherein presenting the at least one comments area includes presenting at least two discrete comments areas.

4. The method of claim 3 wherein presenting at least two discrete comments areas includes presenting a first discrete comments area where only comments from the manufacturer can be displayed and a second discrete comments area where only comments from one of the suppliers can be displayed.

5. The method of claim 4 wherein at least one of the at least two discrete comments areas is scrollable.

6. The method of claim 3 wherein the at least two discrete comments areas are disposed substantially adjacent one another.

7. The method of claim 1 wherein presentation of the resource modification selector section includes presentation of a resource modification selector section where a plurality of new materials to be supplied can be correlated with a plurality of corresponding prior materials, wherein consumption of the prior materials by the manufacturer prior to beginning consumption of the new materials is desired.

8. The method of claim 7 wherein using the integrated change management display includes automatically scheduling a date by when consumption of the plurality of prior materials should be at least substantially concluded as a function of the date by when consumption of the at least one specific material by the manufacturer is scheduled to begin.

9. The method of claim 1 and further comprising storing at least some of the inbound supply chain forecast information in a memory.

10. The method of claim 9 wherein using the integrated change management display to facilitate automatic modification of inbound supply chain forecast information of the at least one prior material includes using the integrated change management display to facilitate automatic modification of the inbound supply chain forecast information other than as stored in the memory.

11. The method of claim 9 and further comprising retrieving at least some of the inbound supply chain forecast information from the memory to provide retrieved information and wherein using the integrated change management display to facilitate automatic modification of inbound supply chain forecast information includes obtaining modification information to be used to automatically modify the retrieved information to conform to forecast information as specified through use of the integrated change management display.

12. The method of claim 1 wherein presenting an identification of at least one specific material to be supplied by at least one of the plurality of suppliers to the manufacturer includes presenting an identification of at least one specific material to be supplied by at least one of the plurality of suppliers to each of a plurality of manufacturing locations of the manufacturer.

13. The method of claim 12 wherein presenting a resource modification selector section includes presenting a resource modification selector section where the at least one specific material to be supplied can be correlated with at least one prior material, wherein completion of consumption of the at least one prior material by the manufacturer at at least one of the plurality of manufacturing locations prior to beginning consumption of the at least one specific material is desired.

14. The method of claim 13 wherein presenting a resource modification selector section where the at least one specific material to be supplied can be correlated with at least one prior material, wherein completion of consumption of the at least one prior material by the manufacturer at at least one of the plurality of manufacturing locations prior to beginning consumption of the at least one specific material is desired includes presenting a resource modification selector section where the at least one specific material to be supplied can be correlated with at least one prior material, wherein completion of consumption of the at least one prior material by the manufacturer at each of the plurality of manufacturing locations prior to beginning consumption of the at least one specific material is desired.

15. The method of claim 1 wherein presenting upon demand by any of the manufacturer and the plurality of suppliers an integrated change management display further includes presenting materials needs forecasting information for the at least one specific material.

16. The method of claim 15 wherein presenting materials needs forecasting information for the at least one specific material further includes:
storing, in base system memory, materials needs forecasting information;
storing, in a middleware application memory, altered materials needs forecasting information;
retrieving materials needs forecasting information from the base system memory;
comparing materials needs forecasting information with altered materials needs forecasting information to identify outdated materials needs forecasting information;
presenting altered materials needs forecasting information to a user in place of outdated materials needs forecasting information until the materials needs forecasting information is no longer outdated.

17. The method of claim 1 wherein presenting upon demand by any of the manufacturer and the plurality of suppliers an integrated change management display further includes presenting upon demand by any of the manufacturer and the plurality of suppliers an integrated change management display through use of a shared network.

18. The method of claim 17 wherein the shared network comprises at least one of a local area network, an intranet, and an internet.

19. The method of claim 1 and further comprising presenting upon demand by any of the manufacturer and the plurality of suppliers an inventory display comprising:
an identification of at least one specific material to be supplied by at least one of the plurality of suppliers to the manufacturer;
days forward coverage information as corresponds to the at least one specific material.

20. The method of claim 19 wherein the days forward coverage information includes days forward coverage information as corresponds to inventory for both the manufacturer and at least one of the suppliers as corresponds to the at least one specific material.

21. The method of claim 19 wherein presentation of days forward coverage information includes presenting, to at least the manufacturer, days forward coverage information that represents overridden information with unique corresponding override indicia.

22. The method of claim 21 wherein the unique corresponding override indicia includes use of at least one of a unique font type and font color.

23. The method of claim 20 wherein at least some of the days forward coverage information includes a corresponding minimum and maximum target metric.

24. The method of claim 23 and further comprising automatically sourcing an exception message to at least the manufacturer whenever an item of days forward coverage information has a quantity that is outside of the corresponding minimum and maximum target metric.

25. The method of claim 24 wherein automatically sourcing an exception message includes automatically sourcing the exception message to the manufacturer and at least one of the plurality of suppliers.

26. The method of claim 19 wherein presenting days forward coverage information as corresponds to the at least one specific material includes providing at least an option to present the days forward coverage information as parsed over a plurality of weeks.
